(19) United States
(12) Patent Application Publication
(10) Pub. No.: US 2007/0097812 A1
(43) Pub. Date: May 3, 2007

(54) Recording information on an otp disc

(76) Inventors: Petrus Jacobus Hubertus Johannes Van Asten, Eindhoven (NL); Wiebe De Haan, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/577,095

(22) PCT Filed: Oct. 27, 2004
(86) PCT No.: PCT/IB04/52214

§ 371 Date: Apr. 25, 2006

(30) Foreign Application Priority Data
Oct. 30, 2003 (EP) 03104021.5

(51) Int. Cl. G11B 7/00

(52) U.S. Cl. 369/44.39

(57) ABSTRACT

A method of recording information stores information on a multilayer record carrier of an opposte track path type (OTP). Logically the OTP disc has a single recording area, but physically a first part (54) is located on layer 0 (L0) and a second part (57) on layer 1 (L1). For recording a first amount ofdata dollowed by a second, larger, amount of data, the size of the first part is adapted to be at least equal to a data size of the second part by recording at least most of the first amount of data in the first part, including a filling area (49) in the first part, and recording at least most of the second amount of data in the second part. This has the advantage that a different amount of data can be accommodated on both layers, while a layer jump is easy.

The invention relates to a method of recording information on a record carrier in a track on a recording layer via a beam of radiation entering through an entrance face of the record carrier, the record carrier comprising at least a first recording layer and a second recording layer, and the track on the first recording layer extending in a first direction and the track on the second recording layer extending in a second direction opposite to the first direction for constituting a recording area having a first part on the first recording layer, a second part on the second recording layer and an intermediate zone located between the first and second part.

The invention further relates to a device and computer program product for recording information on the record carrier.

In particular the invention relates to recording information on a dual layer or multi layer opposite track path (OTP) recordable disc.

A dual layer optical record carrier is known from JP09-231613. The record carrier comprises two recording layers that are optically recordable from the same entrance face of the record carrier. The medium is provided with a stack of two transparent substrates each carrying a recording layer at the inner side. Each recording layer has a spiral track for recording marks representing the information, the tracks having an opposite spiral direction, usually called layers LO and L1 having an opposite track path (OTP). Alternatively a disc with recording layers having the same track direction is called parallel track path (PTP). For OTP at the end of the spiral track at layer LO an intermediate area is provided, and at the same radial position on L1 a second intermediate area is provided. The intermediate area is intended to facilitate a scanning beam arriving at the end of the part of LO containing recorded user data to be re-focused on L1. The scanning process is continued on L1 in the opposite direction at the start of the part of L1 containing recorded user data. L0 contains a first part for user data being preceded by a lead-in zone located at the start of the first recording layer and L1 contains a second part for user data being followed by lead-out information located at the end of the second recording layer. To smooth data readout at the switch of the layers at the end of the first part the intermediate area at L1 is made at least as large as the intermediate area at L0. A problem of the known record carrier is that the data storage capacity or size of L1 is coupled to the size of L0 due to the position of the intermediate areas.

Therefore it is an object of the invention to provide a system of recording on a multilayer record carrier of the OTP type, wherein the data storage capacity can be arranged more flexible.

According to a first aspect of the invention the object is achieved with a method of recording information as described in the opening paragraph, the method comprising receiving a command for recording in the recording area a first amount of data followed by a second amount of data, the second amount being larger than the first amount, and adapting a data size of the first part to be at least equal to a data size of the second part by recording at least most of the first amount of data in the first part, including a filling area in the first part, recording at least most of the second amount of data in the second part, ending the first part by recording a first intermediate area, and recording a second intermediate area located before the start of the second part, the start of the first intermediate area and the end of the second intermediate area having substantially the same radial position and the first intermediate area and the second intermediate area constituting the intermediate zone.

According to a second aspect of the invention the object is achieved with a device for recording information on the record carrier as described in the opening paragraph, the device comprising a head for providing the beam, and a control unit for receiving a command for recording in the recording area a first amount of data followed by a second amount of data, the second amount being larger than the first amount, and adapting a data size of the first part to be at least equal to a data size of the second part by recording at least most of the first amount of data in the first part, including a filling area in the first part, recording at least most of the second amount of data in the second part, ending the first part by recording a first intermediate area, and recording a second intermediate area located before the start of the second part, the start of the first intermediate area and the end of the second intermediate area having substantially the same radial position and the first intermediate area and the second intermediate area constituting the intermediate zone.

The effect of the measures is that the first part is ended after the area assigned to said at least most of the first amount of data and the filling area, and hence the size of the first part is increased with respect to the size required for only storing the first amount of data. The size of the second part depends on the second amount of data. Due to the adaptation of the first part the size thereof is at least equal to the size of the second part. This has the advantage that a different amount of data can be accommodated on both layers, while playback devices making a layer jump from the end of the first part on the first layer to the second layer will find the start of the second part within a short radial distance.

The invention is also based on the following recognition. In practice the record carrier needs to be readable on pre-existing reading devices, for example DVD (Digital Versatile Disc) players. The existing reading devices will perform a layer jump in a predictable way; in particular the existing reading device requires a relation between recorded areas on both layers of an OTP disc, wherein the end of the first part radially corresponds with the start of the second part. Hence the size of the second part is at most equal to the size of the first part. The inventors have seen that in a practical standardized environment also data from a dual layer PTP source may need to be recorded, while said PTP source may provide a first amount of data from a first layer and a second amount of data from a second layer, the second amount being larger than the first amount. It has been noted that in general data cannot be moved to a different layer without affecting the retrieval, e.g. access times to different parts of a file will be influenced if data has been distributed over different layers. Hence a reordering of the data is required which substantially does not affect the retrieval, at least not in a way that the user experiences a difference when using an application from the record carrier. By adjusting the size of recorded parts on the layers moving of data to a different layer may be prevented or limited to moving data which does not affect retrieval.

In an embodiment of the device the control unit is arranged for recording information according to a predefined recording format that includes assigning a logical partition to the recording area, and for shifting start of the partition on the first recording layer in said first direction for said including the filling area in the first part before the start of the partition. This has the advantage that the logical addresses of the user data in the partition are unmodified.

In an embodiment of the device the control unit is arranged for selecting a subset of data from the second amount of data, recording the subset in the filling area in the first part, and recording the second amount of data excluding the subset in the second part. This has the advantage that only for the subset of data a layer different from a source disc is used. In a particular embodiment of the device the data is application data recorded according to a predefined recording format, and the control unit is arranged for selecting the subset in dependence of the application data. The application data is analyzed and selected before being moved to a different layer. This has the advantage that the retrieval of data is affected less.

In an embodiment of the device the application data is video data and the control unit is arranged for selecting the subset in dependence of a natural break that allows data before the natural break to be recorded on the first recording layer and data after the natural break to be recorded on the second recording layer without substantially affecting playback performance. This has the advantage that substantially no changes to the application data are required.

Further preferred embodiments of the method and device according to the invention are given in the further claims.

These and other aspects of the invention will be apparent from and elucidated further with reference to the embodiments described by way of example in the following description and with reference to the accompanying drawings, in which

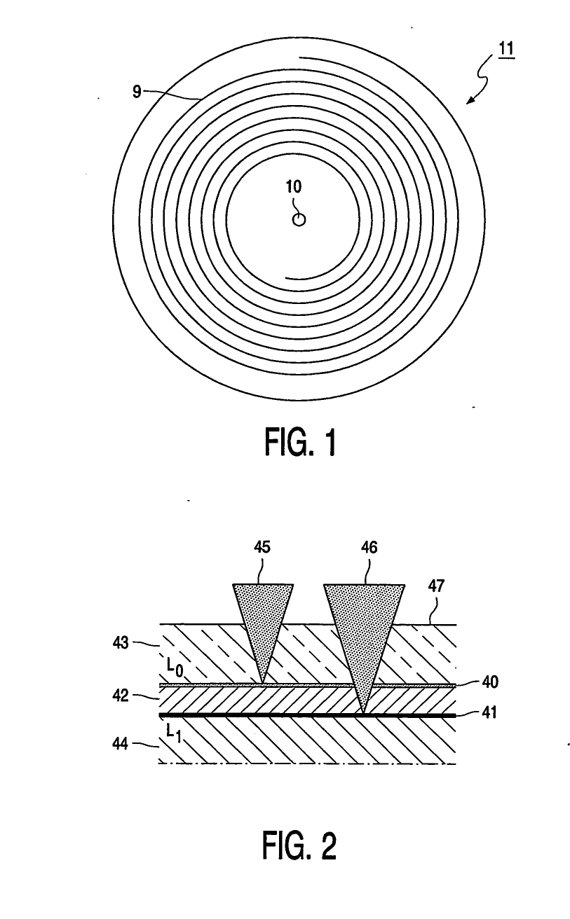

FIG. 1 shows a disc-shaped record carrier,

FIG. 2 shows a multilayer optical disc,

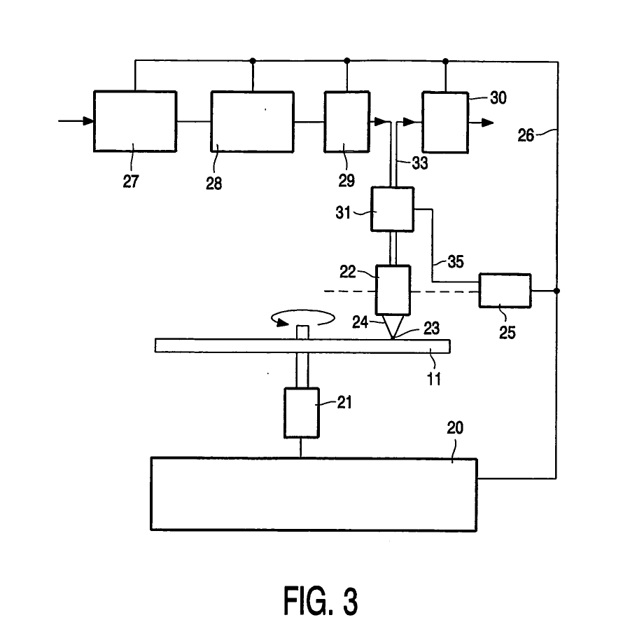

FIG. 3 shows a recording device,

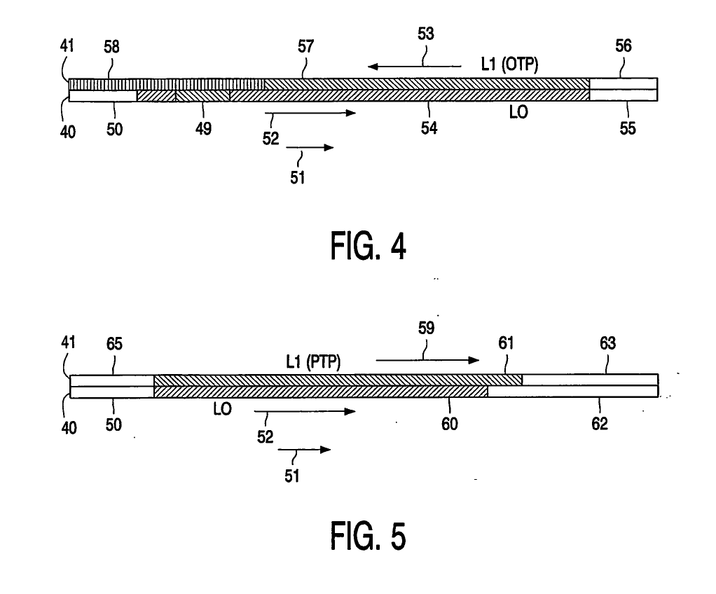

FIG. 4 shows schematically an opposite track path record carrier, and

FIG. 5 shows schematically a parallel track path record carrier.

In the Figures, elements which correspond to elements already described have the same reference numerals.

FIG. 1 shows a disc-shaped record carrier 11 having a track 9 and a central hole 10. The track 9 is arranged in accordance with a spiral pattern of turns constituting substantially parallel tracks on an information layer. The record carrier may be an optical disc of a recordable type, and has at least two recordable information layers. Examples of a recordable disc are the CD-R and CD-RW, and the DVD+RW and DVD+R, and the DVD-RW and DVD-R. The track 9 is indicated by a pre-track structure provided during manufacture of the blank record carrier, for example a pregroove. The pregroove enables a read/write head to follow the track 9 during scanning. The pregroove may be implemented as an indentation or an elevation, or may consist of a material having a different optical property than the material of the pregroove. The pre-track structure may also be formed by regularly spread sub-tracks or pre-pits which periodically cause servo signals to occur. Recorded information is represented on the layer by optically detectable marks recorded along the track. The marks are constituted by variations of a physical parameter and thereby have different optical properties than their surroundings, e.g. in the form of areas with a reflection coefficient different from their surroundings, obtained when recording in materials such as dye, alloy or phase change material, or in the form of areas with a direction of polarization different from their surroundings, obtained when recording in magneto-optical material. The marks are detectable by variations in the reflected beam, e.g. variations in reflection. The record carrier may be intended to carry real-time information, for example video or audio information, or other information, such as computer data.

The system of recording information according to the invention relates to a multilayer record carrier having at least two layers recordable from the same side of the record carrier. In DVD the first recording layer (L0, indicating the layer being first in a logical recording order) is located at a position closer to the entrance face than the second recording layer (L1). It is noted that ‘upper’ layer indicates the layer closest to the entrance face of the laser, and ‘lower’ indicates a layer farther away from the entrance face of the laser, which in practice may be the top or bottom the record carrier depending on the location of the laser. Alternatively the first recording layer L0 may be the lower layer, while L1 and further upper layers (if any) are located closer to the entrance side.

FIG. 2 shows a multilayer optical disc. L0 is a first recording layer 40 and L1 is a second recording layer 41. A first transparent layer 43 covers the first recording layer, a spacer layer 42 separates both recording layers 40,41 and a substrate layer 44 is shown below the second recording layer 41. The first (or upper) recording layer 40 is located at a position closer to an entrance face 47 of the record carrier than the second (or lower) recording layer 41. A laser beam is shown in a first state 45 focused on the L0 layer and the laser beam is shown in a second state 46 focused at the L1 layer.

Multilayer discs are already available as read-only pre-recorded discs, such as DVD-ROM or DVD-Video. A dual layer DVD+R disc has recently been proposed, which disc is to be compatible with the dual layer DVD-ROM standard. The reflection levels of both layers are >18%. The L0 layer has a transmission around 50-70%. A spacer layer separates the layers with a typical thickness between 30 and 60 μm. The L1 layer has a high reflection and needs to be very sensitive. Also rewritable dual-layer discs are proposed. The L0 layer has a transmission around 40-60%. The effective reflection of both layers is typically 7% although lower and higher values are possible (3%-18%). Writable and rewritable optical storage media having 3 or more recording layers are considered also.

FIG. 3 shows a recording device. The device is provided with scanning means for scanning a track on a record carrier 11 which means include a drive unit 21 for rotating the record carrier 11, a head 22, a servo unit 25 for positioning the head 22 on the track, and a control unit 20. The head 22 comprises an optical system of a known type for generating a radiation beam 24 guided through optical elements focused to a radiation spot 23 on a track of the information layer of the record carrier. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. The focusing and tracking actuators are driven by actuator signals from the servo unit 25. For reading the radiation reflected by the information layer is detected by a detector of a usual type, e.g. a four-quadrant diode, in-the head 22 for generating detector signals coupled to a front-end unit 31 for generating various scanning signals, including a main scanning signal 33 and error signals 35 for tracking and focusing. The error signals 35 are coupled to the servo unit 25 for controlling said tracking and focusing actuators. The main scanning signal 33 is processed by read processing unit 30 of a usual type including a demodulator, deformatter and output unit to retrieve the information. The control unit 20 comprises control circuitry, for example a microprocessor, a program memory and control gates. The control unit 20 may also be implemented as a state machine in logic circuits.

The device is provided with recording means for recording information on a multi-layer record carrier of a writable or re-writable type. The recording means comprise an input unit 27, a formatter 28 and a laser unit 29 and cooperate with the head 22 and front-end unit 31 for generating a write beam of radiation. The formatter 28 is for adding control data and formatting and encoding the data according to the recording format, e.g. by adding error correction codes (ECC), synchronizing patterns, interleaving and channel coding. The formatted units comprise address information and are written to corresponding addressable locations on the record carrier under the control of control unit 20. The formatted data from the output of the formatter 28 is passed to the laser unit 29 which controls the laser power for writing the marks in a selected recording layer.

In an embodiment the recording device is a storage system only, e.g. an optical disc drive for use in a computer. The control unit 20 is arranged to communicate with a processing unit in the host computer system via a standardized interface. Digital data is interfaced to the formatter 28 and the read processing unit 30 directly.

In an embodiment the device is arranged as a stand alone unit, for example a video recording apparatus for consumer use. The control unit 20, or an additional host control unit included in the device, is arranged to be controlled directly by the user, and to perform the functions of the file management system. The device includes application data processing, e.g. audio and/or video processing circuits. User information is presented on the input unit 27, which may comprise compression means for input signals such as analog audio and/or video, or digital uncompressed audio/video. Suitable compression means are for example described for audio in WO 98/16014-A1 (PHN 16452), and for video in the MPEG2 standard. The input unit 27 processes the audio and/or video to units of information, which are passed to the formatter 28. The read processing unit 30 may comprise suitable audio and/or video decoding units.

The control unit 20 is arranged for performing the recording functions on a multilayer OTP disc as described below with reference to FIGS. 4 and 5. It is noted that the recording functions may at least partly be performed in a different processing unit, e.g. in a host computer via a software driver.

Due to the required compatibility with existing read-only standardized record carriers, like the DVD-ROM standard, for a DVD-type dual-layer recordable (or rewritable) disc there are two options possible for the layout of the disc. These two options are referred to as ‘parallel track path’ (PTP) and ‘opposite track path’ (OTP), which indicates the direction of the spiral in both layers. In PTP discs there is one information zone per layer (which are logically combined to a single addressable space), while in OTP discs the information zone has a first part on the upper layer (L0) and a second part on the lower layer (L1). In the DVD ROM standard for dual-layer discs in opposite-track-path (OTP) mode, a single information zone is defined extending over the two layers.

FIG. 4 shows schematically an opposite track path record carrier. Arrow 51 indicates the radial position (increasing outward) and arrow 52 indicates the physical addresses, i.e. increasing sector numbers, on layer L0. Arrow 53 indicates the addresses on the L1 layer 41 further increasing going inward. The recording zone have a first part 54 on L0 and a second part 57 on L1, interrupted by a middle zone constituted by a first intermediate part 55 at the end of the recording L0 layer 40 and a second intermediate part 56 at the beginning (in track direction) of the L1 recording layer 41. The recording zone is preceded by a lead-in zone 50 at the beginning of the L0 recording layer and concluded by a lead-out zone 58 at the end of the L1 recording layer. The end of the lead-in zone 50 usually is at a predefined radial position and physical address, e.g. 2FFFFh on DVD, which cannot be modified because existing players used a corresponding fixed offset to calculate logical addresses on L0. An offset for calculating addresses on L1 is stored on the record carrier in a predefined location. The recording zone constitutes a single logical volume, having a single consecutive logical address range.

It is noted that a multilayer disc having more than two layers may have a third intermediate area at the end of the second recording layer and a fourth intermediate area at the beginning of the third recording layer, and so on. The lead-out zone concludes the last recording layer. In the further text “lower layer” or “L1 layer” of a dual layer OTP disc are used for explaining the invention, which are deemed to include further lower layers in the event of discs having more than two layers.

FIG. 5 shows schematically a parallel track path record carrier. Arrow 51 indicates the radial position (increasing outward) and arrow 52 indicates the physical addresses, i.e. increasing sector numbers, on layer L0. Arrow 59 indicates the addresses on the L1 layer 41 also increasing going outward. A first recording zone 60 on L0 is preceded by lead-in zone 50 and ended by lead-out zone 62. A second recording zone 61 on L1 is preceded by lead-in zone 65 and ended by lead-out zone 63. It is to be noted that in DVD the physical addresses on both layers are numbered equal, starting at 30000h after the lead-in zone. However a single logical address volume is defined including both recordable zones, wherein consecutively numbered logical addresses start at 0.

In many cases OTh discs are used for movies on DVD-Video discs, because the layer jump in the middle of a movie is much shorter than with a PTP disc. Most of today's DVD players are able to play (near) seamlessly across an OTP layer track jump. However, in some cases the content provider prefers a PTP disc. For example, when the movie is short enough to fit on the first layer (L0), the bonus material can be added on the second layer (L1). In this case there is no need for a (near) seamless layer jump. The same bonus content can simply be added to different language versions of the disc, without the need for re-authoring.

A problem occurs when a user wants to record data on an OTP dual-layer recordable disc, when the amount of data for the L1 layer is larger then the amount of data for the L0 layer, for example if the user makes a copy of a PTP disc having a larger L1 layer as shown in FIG. 5. Although both types of discs contain just one logical volume, PTP discs with an L1 that is bigger than L0 cannot simply be copied to an OTP disc. For example DVD-Video has special requirements concerning the location of a layer break, but also other applications may rely on certain rules for real-time file allocation, e.g. they must be completely contained on one of the layers.

According to the invention a recording method is provided for receiving a command for recording in the recording area a first amount of data followed by a second amount of data, the second amount being larger than the first amount. When detecting such a command the data size of the first part (on layer L0) of the recording area of the OTP disc is adapted to be at least equal to a data size of the second part (on layer L1). The first amount of data is recorded in the first part. Additionally a filling area (49) is included in the first part to increase the data size of layer L0, as shown in FIG. 4. The second amount of data is recorded in the second part on L1. It is noted that additionally, as described below, some data of the second amount may be recorded on L0, and/or some data of the first amount may be recorded on L1. Both recording area parts are preceded and followed by lead-in zone, intermediate areas, and lead-out zone as described above. By including the filling area (49) the data size of the first part is adapted while the start of the first intermediate area and the end of the second intermediate area substantially are positioned at the same radial position.

In an embodiment the filling area is given the size of the difference between the data size of the second amount (e.g. from a source L1 layer) minus the data-size of the first amount (e.g. from a source L0 layer). Hence L0 now has the same size as L1. The filling area may be left unrecorded. For compatibility with read-only discs unrecorded areas of the record carrier may be required to be recorded.

In an embodiment filling data, e.g. data blocks filled with zero data or prescribed values according to a standard, are recorded in unrecorded parts of the track. For example unrecorded parts where accessing of a different recording layer is expected are to be recorded. During recording real-time data like video it may not be possible to record the intermediate parts. Hence when the recording is terminated, the intermediate parts are additionally recorded by writing filling data, at least partially in the radial area where accessing of the lower layer is expected.

In an embodiment the control unit 20 is arranged for selecting a subset of data from the second amount of data, recording the subset in the filling area in the first part, and recording the second amount of data excluding the subset in the second part. Hence most of the second amount of data is recorded on L1. For example when the location of the layer break doesn't matter for the application, a portion of data from the beginning of the second amount (from source L1) is recorded in the filling area on L0. That same portion of data is removed from the second amount before recording the beginning of layer 1. For example the filling area has a size of 50% of the difference of the first amount and the second amount of data and is located at the end of the first part. Now the total size of the recording zone remains unchanged and logical sector addresses may remain identical to the original. It is noted that such a method can usually not be applied to DVD-Video discs without affecting the playback performance.

In an embodiment the information is recorded according to a predefined recording format that includes assigning a logical partition to the recording area. The method comprises shifting start of the partition on the first recording layer towards the end of the first part. A filling area is included between the control information at the beginning of the first part and the shifted start of the partition. In particular the method is applicable for discs containing the UDF file system, like DVD-Video discs and DVD-ROM discs for the PC and Mac platform. According to the UDF file system a logical partition is defined in the recording area Further details about UDF can be found in document ECMA-167 “Volume and File Structure for Write-Once and Rewritable Media using Non-Sequential Recording for Information Interchange”. For making the data size on L0 at least identical to the data size on L1 on the source, the method comprises the following. The UDF partition on L0 is shifted unmodified towards the end of the enlarged L0 on the target disc. UDF data structures in front of the partition stay in the same position relative to the start of the layer; the UDF Partition Descriptor in the Main and Reserve Volume Descriptor Sequence is updated to reflect the changed location of the partition (see ECMA-167 3/10.5). The data from layer 1 of the source is copied with just a minor modification: the 2nd AVDP is updated to reflect the change of the size of the available space (see Tag Location, ECMA-167 3/7.2).

In a further embodiment the logical volume also contains an ISO-9660 file system (e.g. UDF Bridge). Because ISO 9660 does not have a reference starting point which may be adapted, the addresses of files are to be updated to reflect the changed location of the files. The amount of shift of the start of the UDF partition is to be added to the file addresses. Volume descriptors of the ISO-9660 system on predefined addresses are to be adapted to the new size of the volume. Alternatively the ISO-9660 information may be omitted, because most players only use the UDF information.

The proposed solution has the advantages that user data is not modified, and therefore method is independent of applications stored on the record carrier; all user data stays on the same layer as on the source, and all user data stays in the same relative position with respect to UDF partition start (important for files in DVD-Video zone), including location of layer boundary.

In an embodiment the data is application data recorded according to a predefined recording format such as video data recorded according to the DVD-Video standard. The control unit (20) is arranged for selecting a subset of data in dependence of the application data as explained hereafter.

In a first embodiment the DVD-Video application data is examined to check for the presence of “natural breaks”. Natural breaks are locations within the logical volume where layer breaks are possible without compromising playback performance. Preferably the control unit (20) is arranged for selecting the natural break at a boundary between recording units. The recording unit is the smallest amount of data that is recordable including error correcting codes according to the predefined recording format, such as ECC blocks in DVD.

Examples of natural breaks are: sectors that do not contain real-time video data (VOB files) but PC data or control data, non-seamless connections in the VOB-file data, etc. The information indicating such seamless connections is included in cell playback information in the DVD-Video format (C_PBI in the program chain information PGCI, which information controls the playback of the video in the VOB files). It is not necessary to scan all data that is to be recorded, because the natural breaks can be found by examining video control and information files (on DVD-Video the so-called ifo-files for video title sets: VIDEO_TS.ifo, VTS_{—}01_{—}0_.ifo, etc). If a natural break can be found such that L0≧L1 and L0 and L1 each fit on a single layer, data can be recorded while applying the new layer breakpoint. No changes to the content of the volume are required.

In a second embodiment, if natural breaks cannot be detected, a natural break is generated. A natural break may be created by shifting the DVD-Video zone to create the condition for a natural break. To achieve this, dummy data can be inserted in front of the DVD-Video zone. For instance, a non-seamless connection between Cells could be positioned on an ECC block boundary. Data before the natural break is moved to the filling area on L0, such that L0 becomes at least equal in size compared with L1. In general the logical volume is increased if this method must be applied and the file system structures must be updated to reflect the file location change. Playback performance is not affected in this embodiment

In a third embodiment the control unit 20 is arranged for shifting of application data by inserting other data within an application data zone containing the application data for generating the natural break. The other data may be dummy data, or data which are not affecting playback performance. For example in the video application data zone on a DVD disc, it may be possible to insert dummy data in between Video Title Sets or between the Video Manager and the first Video Title Set to meet the criteria for a natural break. In that case, also the contents of the Video Manager Information file (VGMI) must be updated, because the VMGI contains pointers and addresses relative to the logical starting address of VMGI. In a further embodiment dummy data is inserted in between ifo and vob files or in between menu and title vob files to generate a natural break. In that case, also the contents of the Video Title Set Information file of the Video Title Set must be updated, because the VTSI contains relative addresses.

In a fourth embodiment the control unit 20 is arranged for generating the natural break by adapting application status information to a status which indicates that a connection of video data cells is of a non-seamless playable type. For example if no natural breaks can be forced by inserting dummy data, status information indicating seamless connections between Cells may be adapted to non-seamless for allowing a layer break. By changing a seamless into a non-seamless connection, and perhaps shift the VTS or DVD-Video zone to align it with an ECC-block boundary, the now non-seamless connection can be used for the natural break. If no data insertion is necessary, this step may be preferred above the previous ones, as no file system changes are necessary and the changes to the DVD-Video Information files are very small.

It is noted that in the event a pre-existing natural break is found, the recording can be made without any changes to the data. In the event that a natural break can be generated by inserting dummy data in front of or within the DVD-Video zone, an additional non-seamless connection is avoided. In the event that a seamless connection can be changed into a non-seamless connection, re-authoring, re-multiplexing or re-encoding can be avoided. Furthermore, instead of inserting dummy data in front of the DVD-Video zone, PC data files that may be present on the original DVD-Video disc could be moved to a location in front of the DVD-Video zone. In this way, the available space is used more efficiently.

Although the invention has been mainly explained by embodiments using dual layer optical discs having spiral shaped tracks, the invention is also suitable for other record carriers such as rectangular optical cards, magneto-optical discs, magnetic discs or any other type of information storage system that has a multitude of recordable layers, which are to be recorded in opposite directions. Furthermore the proposed methods can also be applied when a single large amount of video content formatted according to predefined video specifications is available on some storage medium (e.g. HDD), and has to be copied to a dual-layer recordable disc. The DVD-Video content might have been created by a software tool, or might have been copied earlier from a dual-layer DVD-Video disc. In the latter case, the layer breakpoint is not visible in the content itself, but can be selected in the above indicated way as a natural break.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Method of recording information on a record carrier in a track on a recording layer via a beam of radiation entering through an entrance face of the record carrier, the record carrier comprising
at least a first recording layer (40) and a second recording layer (41), and
the track on the first recording layer extending in a first direction and the track on the second recording layer extending in a second direction opposite to the first direction for constituting a recording area having a first part (54) on the first recording layer, a second part (57) on the second recording layer and an intermediate zone (55,56) located between the first and second part, the method comprising
receiving a command for recording in the recording area a first amount of data followed by a second amount of data, the second amount being larger than the first amount, and
adapting a data size of the first part (54) to be at least equal to a data size of the second part (57) by
recording at least most of the first amount of data in the first part,
including a filling area (49) in the first part,
recording at least most of the second amount of data in the second part,
ending the first part by recording a first intermediate area (55), and
recording a second intermediate area (56) located before the start of the second part,
the start of the first intermediate area and the end of the second intermediate area having substantially the same radial position and the first intermediate area and the second intermediate area constituting the intermediate zone.

2. Method as claimed in claim 1, wherein the method comprises recording information according to a predefined recording format that includes assigning a logical partition to the recording area, and the method comprises shifting start of the partition on the first recording layer in said first direction for said including the filling area (49) in the first part before the start of the partition.

3. Method as claimed in claim 1, wherein the method comprises
selecting a subset of application data from the second amount of data in dependence of the application data,
recording the subset in the filling area (49) in the first part, and
recording the second amount of data excluding the subset in the second part.

4. Computer program product for recording information, which program is operative to cause a processor to perform the method as claimed in claim 1.

5. Device for recording information on a record carrier in a track on a recording layer via a beam of radiation entering through an entrance face of the record carrier, the record carrier comprising
at least a first recording layer (40) and a second recording layer (41), and
the track on the first recording layer extending in a first direction and the track on the second recording layer extending in a second direction opposite to the first direction for constituting a recording area having a first part (54) on the first recording layer, a second part (57) on the second recording layer and an intermediate zone (55,56) located between the first and second part,
the device comprising
a head (22) for providing the beam, and
a control unit (20) for
receiving a command for recording in the recording area a first amount of data followed by a second amount of data, the second amount being larger than the first amount, and
adapting a data size of the first part (54) to be at least equal to a data size of the second part (57) by
recording at least most of the first amount of data in the first part,
including a filling area (49) in the first part,
recording at least most of the second amount of data in the second part,
ending the first part by recording a first intermediate area (55), and
recording a second intermediate area (56) located before the start of the second part,
the start of the first intermediate area and the end of the second intermediate area having substantially the same radial position and the first intermediate area and the second intermediate area constituting the intermediate zone.

6. Device as claimed in claim 5, wherein the control unit (20) is arranged for recording information according to a predefined recording format that includes assigning a logical partition to the recording area, and for shifting start of the partition on the first recording layer in said first direction for said including the filling area (49) in the first part before the start of the partition.

7. Device as claimed in claim, wherein the control unit (20) is arranged for
selecting a subset of data from the second amount of data,
recording the subset in the filling area (49) in the first part, and
recording the second amount of data excluding the subset in the second part.

8. Device as claimed in claim 7, wherein the data is application data recorded according to a predefined recording format, and the control unit (20) is arranged for selecting the subset in dependence of the application data.

9. Device as claimed in claim 8, wherein the application data is video data and the control unit (20) is arranged for selecting the subset in dependence of a natural break that allows data before the natural break to be recorded on the first recording layer and data after the natural break to be recorded on the second recording layer without substantially affecting playback performance.

10. Device as claimed in claim 9, wherein the control unit (20) is arranged for selecting the natural break at a boundary between recording units, the recording units being the smallest amount of data that is recordable including error correcting codes according to the predefined recording format.

11. Device as claimed in claim 9, wherein the control unit (20) is arranged for shifting of application data by inserting other data before or within a zone containing the application data, the other data being dummy data or data which are not affecting playback performance, for generating the natural break.

12. Device as claimed in claim 9, wherein the control unit (20) is arranged for generating the natural break by adapting application status information to a status which indicates that a connection of video data cells is of a non-seamless playable type.
